(19) United States
(12) Patent Application Publication
(10) Pub. No.: US 2002/0140683 A1
(43) Pub. Date: Oct. 3, 2002

(54) Binary signature device system

(76) Inventor: Robert Carlback, Stockholm (SE)

Correspondence Address: ROLF FASTH, 189 CURTIS DRIVE, LONGVIEW, WA, 98632-5374, US

(21) Appl. No.: 09/820,019

(22) Filed: Mar. 28, 2001

(51) Int. Cl. G09G 5/00

(52) U.S. Cl. 345/179

(57) ABSTRACT

The method is used to identify a handwritten signature that is unique to the user. The computer system is activated by inserting an electronic pen into an activation opening defined in the electronic writing unit. The electronic pen is applied on the electronic writing unit and moved on the electronic writing unit to create a unique signature of the user. The movement of the electronic pen is recorded in a database of the computer system. The movement is compared with movements of a pre-recorded signature of the user and an acceptance signal is provided when the recorded movement is between a maximum and a minimum value of the movements of the pre-recorded signature.

### TECHNICAL FIELD

The present invention relates to a binary signature device system that has a writing unit connected to a computer system and an electrical pen that may be used to write on the writing unit.

### BACKGROUND AND SUMMARY OF THE INVENTION

The need to identify oneself before gaining access into various computer systems is increasing. For example, it is necessary to provide some unique identification before the user may gain access to automatic bank teller machines or before buying products on the Internet or entering a pass control of a new country. Personal identification (PIN) numbers and signatures are commonly used. There are many drawbacks with the current identification methods. For example, PIN numbers are difficult to remember since there are often so many different PIN numbers to remember. Signatures are subject to fraud and other illegal copying. There is a need for a reliable identification method that is convenient to use and difficult to copy in a fraudulent manner.

The method of the present invention is an effective method of identifying a handwritten signature that is unique to the user. The computer system is activated by inserting an electronic pen into an activation opening defined in the electronic writing unit. The electronic pen is applied on the electronic writing unit and moved on the electronic writing unit to create a unique signature of the user. The movement of the electronic pen is recorded in a database of the computer system. The movement is compared with movements of a pre-recorded signature of the user and an acceptance signal is provided when the recorded movement is between a maximum and a minimum value of the movements of the pre-recorded signature.

### BRIEF DESCRIPTION OF THE DRAWINGS

FIG. 1 is a perspective view of the binary signature device system of the present invention.

### DETAILED DESCRIPTION

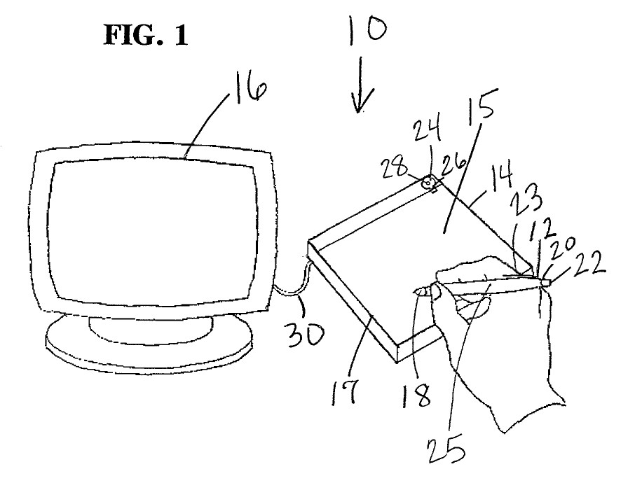

With reference to FIG. 1, the present invention is a binary signature device system 10 that has an electronic pen 12, an electronic writing unit 14 that is connected to a computer system 16 so that the user may use the pen 12 to write his/her signature, initials or any other unique written marking related to a certain person, on the writing unit 14 and the signature is conveyed into the computer system 16. The computer may be a personal computer, palm computer or a mobile telephone that is connected to the Internet or a bankomat that is connected to a bank's database or an entire computer network system.

In the preferred embodiment, the pen 12 has a size that is similar to a conventional pen and the pen 12 has a tip 18 that may be made of a suitable rubber material so that the pen 12 feels like a conventional pen when writing on the writing unit 14. A top end 20 of the pen 12 has a male contact 22. The pen 12 may be used to write the user's signature and other messages on the writing unit 14. The pen has a clip-on fastener 23 that protrudes outwardly similar to conventional pens. The pen 12 has a programmable memory chip 25, such as a PROM memory, that may memorize information such as personal information about the user, including, but not limited to, the name, social security number, age, birth place, nationality, credit and bank account numbers, photo and other personal information. In other words, the pen 12 may function as an identification card.

An important feature of the present invention is that a person's signature may be used to uniquely identify the person and replace the various passwords and other codes that are required by institutions such as banks, secured buildings and other authorities that has information that is protected from the public.

The writing unit 14 may include a suitable electronic upper surface 15, such as a floating crystal matrix, that visually shows and/or digitally recognizes the text that is being written on the writing unit 14 with the pen 12. The upper surface 15 has matrices of pixel cells that have a size that is adjusted to the size of the tip 18 of the pen 12 so that the tip 18 touches at least one cell but at the most three cells at a time. This is to eliminate any undesirable registration effects of the hand resting on the writing unit 14 during the writing procedure. The upper surface 15 may record not only the optical print of the unique signature but also the speed of the tip 18, the acceleration and deceleration during the signature. The upper surface 15 may also measure the total time of signature from the start until the signature is complete. The writing unit 14 may also record other factors such as the time between the first name and the last name, etc. All these data make it very difficult to falsify the signature by another unauthorized person.

Below the upper surface 15 is a pressure sensitive matrix surface 17 that may measure the pressure difference in different segments of the signature.

The writing unit 14 should have a suitable size such as A4 or 8.5″×11″. Of course, the size could be larger or smaller. For example, if the signature is the only requirement, the size could be much smaller to accommodate most signatures. The writing unit 14 has an opening 24 defined therein. For example, the opening 24 could be located at one corner of the writing unit 14 to free up the surface of the signature writing with the pen 12. The opening 24 has an elongate groove 26 and a female contact 28 at the bottom of the opening 24.

In operation, the first time the user uses the pen 12, the computer 16, that is connected to a database or the Internet, need to record the signature to establish a reference signature. The user may be asked to write his/her signature about five or six times on the writing unit 14. The user may be asked to record the signature more or less than six times, as desired. After each signature, the user may be asked to wait about 30 seconds or so to enable to the user to calm down between each recording session to improve the accuracy of the signatures. Of course, the waiting time may not be necessary and is not a requirement.

During the recording, the writing unit 14 measures, as indicated above, the pressure variations of the tip 18 on the writing unit 14, the acceleration and deceleration of the pen during the signature, the total time of the signature, the relative time of the first name and last name compared to the total time and the density of the signature. The optical look of the signature/initials may be determined by automatically forming a rectangular frame around the already written signature/initials. This frame may form the base for a xy-axis coordinate system in order to fixate the signature/initials so that the optical look and the position of the signature/initials may always be established and compared. Other factors may also be measured, as desired. For example, the number of cells that are affected by the signature/initials within the frame may be compared to the total number of cells within the frame, thus making it possible to calculate the density of the signature/initials. This may be necessary if the signature, for some reason, is enlarged or reduced compared to the reference signature that may, for example, have a default density of one (1). Any scaling up or down of the signature density may interfere with other physical parameters and the parameters may be adjusted according to feedback.

The recorded information from the signatures is transmitted from the writing unit 14 via a link 30 connected to the computer unit 16. In the case of a palm computer, a mobile telephone or any other wireless device, no link 30 is, of course, necessary. For example, a palm computer or a mobile telephone, connected to the Internet, may contain all the components of the present invention except for the pen 12 and rely on bluetooth or infrared communication technology. The computer 16 analyzes the signature information and may, for example, store the highest and the lowest value, and other statistical data, of each recording. All this information is stored in a database of the computer 16 to establish the required reference signature for the particular user.

After the reference signature is stored in the database of the computer system 16, the user may use the pen 12 to gain access to information on the database such as withdrawing money from his/her bank account, buying products on the Internet or enter a pass control in a new country.

To initiate the process of gaining access to the database, the user first inserts the male contact 22 of the pen 12 into the opening 24 so that the clip-on fastener 23 is guided by the groove 26 to ensure that the male contact 22 is properly connected to the female contact 28 inside the opening 24. Other ways of connecting the pen to the surface unit are also possible.

When the pen 12 is connected to the surface unit 14, a request signal is sent to the computer 16 to gain access to a particular database, such as credit cards, library cards, etc., that relates to the owner of the pen 12. The computer 16 sends back an identification request by asking the user to write his signature on the writing unit 14 before sensitive or confidential information is visually displayed on the computer 16. This request has the same function as PIN and passwords of, for example, conventional bankomats. After the user has finished writing the signature, the pen 12 may again be inserted into the opening 24 and the computer system 16 compares the signature with the reference signature in the database. If the signature sufficiently matches the reference signature, the computer 16 will approve the signature as genuine and give the user access to the databases such as, bank accounts, and the user can transact the business with the bank in a conventional manner or buy products on the Internet and charge the purchase to a credit card.

While the present invention has been described in accordance with preferred compositions and embodiments, it is to be understood that certain substitutions and alterations may be made thereto without departing from the spirit and scope of the following claims.

I claim:

1. A method of identifying a handwritten signature that is unique to the user, comprising:
providing an electronic pen and an electronic writing unit in communication with a computer system;
a user applying a pressure on the electronic writing unit by the electronic pen at a first time;
moving the electronic pen on the electronic writing unit and varying the pressure by the electronic pen on the electronic writing unit to create a unique signature of the user;
applying the pressure at a second time that is subsequent the first time;
measuring a time difference between the first time and the second time;
measuring pressure variations by the electronic pen on the electronic writing unit when the electronic pen is moved on the electronic writing unit by the user; and
comparing the time difference and pressure variations with time differences and pressure variations of a pre-recorded signature by the user.

2. The method according to claim 1 wherein the method further comprises measuring a speed of the electronic pen when the electronic pen is moved on the electronic writing unit and comparing the speed with a speed of the electronic pen during the pre-recorded signature.

3. The method according to claim 1 wherein the method further comprises measuring an acceleration of the electronic pen when the electronic pen is moved on the electronic writing unit and comparing the acceleration with an acceleration of the electronic pen during the pre-recorded signature.

4. The method according to claim 1 wherein the method further comprises measuring the pressure difference between segments of the signature and comparing the pressure difference with pressure difference in the same segments of the pre-recorded signature.

5. The method according to claim 1 wherein the method further comprises measuring a relative time requirement to complete a first name of the signature and a relative time requirement to complete a last name and comparing the relative times with a total time requirement to complete the signature.

6. The method according to claim 1 wherein the method further comprises measuring a total number of units activated on the electronic writing unit and comparing the total number with a total number of units activated on the pre-recorded signature.

7. The method according to claim 6 wherein the method further comprises calculating a utilization density of the electronic writing unit.

8. The method according to claim 1 wherein the computer transmits an approval signal when the time difference is between a predetermined maximum value and a minimum value.

9. The method according to claim 1 wherein the method further comprises providing the electronic writing unit with an opening defined therein and inserting the electronic pen into the opening to activate the computer.

10. A method of identifying a handwritten signature that is unique to the user, comprising:
providing an electronic pen and an electronic writing unit in communication with a computer system;
activating the computer system by inserting the electronic pen into an activation opening defined in the electronic writing unit;
applying the electronic pen on the electronic writing unit;
moving the electronic pen on the electronic writing unit to create a unique signature of the user;
recording the movement of the electronic pen in a database of the computer system;
comparing the movement with movements of a prerecorded signature of the user; and
providing an acceptance signal when the recorded movement is between a maximum and a minimum value of the movements of the pre-recorded signature.

11. The method according to claim 10 wherein the method further comprises measuring a speed and pressure of the electronic pen when the electronic pen is moved on the electronic writing unit and comparing the speed with a speed of the electronic pen during the pre-recorded signature.

12. The method according to claim 10 wherein the method further comprises measuring an acceleration of the electronic pen when the electronic pen is moved on the electronic writing unit and comparing the acceleration with an acceleration of the electronic pen during the pre-recorded signature.

13. The method according to claim 10 wherein the method further comprises measuring a pressure difference between segments of the signature and comparing the pressure difference with pressure difference in the same segments of the pre-recorded signature.

14. The method according to claim 10 wherein the method further comprises measuring a time requirement to complete the signature and comparing the time requirement with a time requirement to complete the pre-recorded signature.

15. The method according to claim 10 wherein the method further comprises measuring a total number of units activated on the electronic writing unit and comparing the total number with a total number of units activated on the pre-recorded signature.

16. The method according to claim 10 wherein the method further comprises providing the electronic writing unit with an opening defined therein and inserting the electronic pen into the opening to activate the computer.

17. The method according to claim 10 wherein the method further comprises providing the electronic pen with a memory unit for storing personal data thereon.
